(19) United States
(12) Patent Application Publication
(10) Pub. No.: US 2012/0185636 A1
(43) Pub. Date: Jul. 19, 2012

(54) Tamper-Resistant Memory Device With Variable Data Transmission Rate

(75) Inventors: John Leon, Anaheim, CA (US); W. Eric Boyd, La Mesa, CA (US); Sambo He, Riverside, CA (US); Christian Krutzik, Costa Mesa, CA (US)

(73) Assignee: ISC8, Inc., Costa Mesa, CA (US)

(21) Appl. No.: 13/363,571

(22) Filed: Feb. 1, 2012

Related U.S. Application Data
(63) Continuation-in-part of application No. 12/806,127, filed on Aug. 4, 2010.
Application No. 12/806,127 is a continuation-in-part of application No. 13/045,880, filed on Mar. 11, 2011.
(60) Provisional application No. 61/439,236, filed on Feb. 3, 2011.
(60) Provisional application No. 61/439,242, filed on Feb. 3, 2011.
(60) Provisional application No. 61/439,252, filed on Feb. 3, 2011.
(60) Provisional application No. 61/439,255, filed on Feb. 3, 2011.
(60) Provisional application No. 61/439,257, filed on Feb. 3, 2011.
(60) Provisional application No. 61/439,259, filed on Feb. 3, 2011.

(51) Int. Cl. G06F 12/00; G06F 12/02

(52) U.S. Cl. 711/102; 711/154; 711/E12.001; 711/E12.008

(57) ABSTRACT

A high capacity, secure and tamper-resistant computer data memory device. The device uses a plurality of dedicated memory controller elements in communication with an anti-tamper module that generates a tamper response when a predetermined tamper event occurs. The tamper response may be provided as the erasure or zeroization of the contents of a memory in the devices such as erasing one or more encryption keys. The elements of the device are preferably provided in a stacked configuration with rerouted I/O pads to obfuscate the I/O and function of the devices in the stack. In one embodiment, a data transfer governance means is provided. In a further embodiment, a current negotiation means is disclosed to permit the device to request a predetermined current from a host device. In a yet further embodiment, a portable safe house computing device is provided.

### CROSS-REFERENCE TO RELATED APPLICATIONS

This application claims the benefit of U.S. Provisional Patent Application No. 61/439,236, filed on Feb. 3, 2011 entitled “USB Memory Device Comprising Locking Feature” pursuant to 35 USC 119, which application is incorporated fully herein by reference.

This application claims the benefit of U.S. Provisional Patent Application No. 61/439,242, filed on Feb. 3, 2011 entitled “Dual Connection USB Device” pursuant to 35 USC 119, which application is incorporated fully herein by reference.

This application claims the benefit of U.S. Provisional Patent Application No. 61/439,252, filed on Feb. 3, 2011 entitled “USB Device Comprising Anti-tamper Means” pursuant to 35 USC 119, which application is incorporated fully herein by reference.

This application claims the benefit of U.S. Provisional Patent Application No. 61/439,255, filed on Feb. 3, 2011 entitled “Variable Current, High Bandwidth USB Device” pursuant to 35 USC 119, which application is incorporated fully herein by reference.

This application claims the benefit of U.S. Provisional Patent Application No. 61/439,257, filed on Feb. 3, 2011 entitled “USB Device Comprising Means for Data Throttling” pursuant to 35 USC 119, which application is incorporated fully herein by reference.

This application claims the benefit of U.S. Provisional Patent Application No. 61/439,259, filed on Feb. 3, 2011 entitled “USB Safe House Computing and Storage Device” pursuant to 35 USC 119, which application is incorporated fully herein by reference.

This application is a continuation-in-part of U.S. patent application Ser. No. 12/806,127, filed on Aug. 4, 2010 entitled “Tamper-Resistant Electronic Circuit and Module Incorporating Conductive Nano-Structures”, and Ser. No. 13/045,880 filed on Mar. 11, 2011 entitled “Secure Anti-Tamper Integrated Circuit Layer Security Device Comprising Nano-Structures,” which applications are incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of computer data memory devices.

More specifically, the invention relates to high-speed and secure portable computer data memory devices such as USB (i.e., Universal Serial Bus) computer data memory devices having power management and variable data transmission rate features and anti-tamper and user-authorization features to prevent or inhibit access to a function or memory contents of the device.

2. Description of the Related Art

A growing demand exists for high capacity, portable computer data memory devices that are both secure from access from an unauthorized user and that have data transfer rates and power consumption compatible with USB 3.0 specifications (sometimes referred to as SuperSpeed USB).

While the current specification for USB 2.0 provides for data transmission speeds up to 480 Mbit/s with a related maximum power consumption specification of about 2.5 watts, the current USB 3.0 specification provides for a data transmission speed of up to 5 Gbits/s; a 10× increase in speed over USB 2.0 but with a maximum power consumption specification increase to only about 4.5 watts.

The dramatically increased data transmission speeds of USB 3.0 over USB 2.0, coupled with a relatively nominal limit increase in maximum power consumption, presents unique design issues for such portable devices. This is particularly true in view of the fact memory capacity consumer demand for portable USB devices operating at higher transmission speeds but with lower power requirements is increasing, with terabyte-level USB drives becoming commonplace.

Concurrent with the USB issues noted above (i.e., power vs. data transmission speed), data security with respect to the memory contents and access to internally stored data, encryption keys or other code in a portable computer memory device is needed.

For instance, digital media from commercial studio operations such as digital movies or music is particularly vulnerable to digital theft and is valuable both prior to and after release for distribution to retail and other establishments. A copyright owner's interests in media that is stolen during distribution and made available on illegal websites prior to authorized release and sale can be dramatically affected and the commercial value of that media diminished as a result when later made available through legal commercial channels.

Relatedly, medical, financial, trade secret or government-classified information that is compromised during shipping or physical transfer in the form of conventional computer data storage such as a non-secure USB flash drive, DVD or hard drive can result in the theft of sensitive or valuable data that, once released to an unauthorized person, cannot be re-secured.

The invention herein, in its various preferred embodiments, addresses the above need for secure, high-density, high-speed portable computer storage devices in the form of a tamper-resistant, computer data storage device with power management and data governing features to address power consumption limitations of USB 3.0 devices with the capability of providing a portable “safe-house” computing” environment to a user.

### BRIEF SUMMARY OF THE INVENTION

In a first aspect of the invention, a computer data memory device is disclosed comprising a plurality of computer memory elements configured as a plurality of memory banks, a plurality of memory controller elements configured to provide a dedicated memory controller element to each of the plurality of memory banks for the independent management of data transfer into and out of the respective computer memory elements in the respective memory banks wherein at least one of the memory controller elements is electrically coupled to the bridge circuit means for the translation of communication protocols between the computer data memory device and an external device such as a host PC.

In a second aspect of the invention, a computer data memory device is disclosed comprising wherein at least one of the memory controller elements is electrically coupled to an anti-tamper module that is electrically coupled to bridge circuit means for the translation of communication protocols between the computer data memory device and an external device.

In a third aspect of the invention, the anti-tamper module performs a data encryption or decryption operation or may store one or more data encryption keys in an anti-tamper module memory location.

In a fourth aspect of the invention, the device is provided as a stack of electrically coupled integrated circuit layers wherein at least one of the layers comprises a computer memory element.

In a fifth aspect of the invention, the anti-tamper module is configured with one or more physical or electrical tamper sensors configured to sense a variance in a predetermined electrical characteristic whereby a predetermined variance in the predetermined electrical characteristic initiates a predetermined tamper response from the anti-tamper module.

In a sixth aspect of the invention, the predetermined electrical characteristic comprises a predetermined electrical resistance.

In a seventh aspect of the invention, the predetermined electrical characteristic comprises a predetermined electrical capacitance.

In an eighth aspect of the invention, the predetermined electrical characteristic comprises a predetermined electrical inductance.

In a ninth aspect of the invention, the predetermined tamper response comprises erasing a memory contents of a computer memory element or erasing an encryption or decryption key stored in the anti-tamper module, the computer memory element or both.

In a tenth aspect of the invention, the predetermined variance is sensed as a result of an open connection in a wire bond segment embedded in an encapsulating material of the device.

In an eleventh aspect of the invention, the predetermined variance is sensed as a result of a change in an electrical continuity through a wire bond segment embedded in an encapsulating material of the device.

In a twelfth aspect of the invention, the anti-tamper module comprises a real time clock circuit configured to permit time-based access to the contents of at least one computer memory element based on a predetermined tamper event which tamper event could, for instance, be the installation of the device into a host computer, removal of a USB connector cap or cover or other user-defined event.

In a thirteenth aspect of the invention, the device may comprise a stack of electrically coupled integrated circuit layers wherein at least one of the layers comprises a memory controller element and at least one of the layers comprises an anti-tamper module.

In a fourteenth aspect of the invention, the stack of layers comprises a layer comprising multiplexing circuit means for multiplexing data being transferred from and to a first predetermined memory controller element and a second predetermined memory controller element.

In a fifteenth aspect of the invention, the device is configured to communicate with a host device such as a PC whereby the device of the invention operates at a predefined device operation parameter based on a predefined host communication response.

In a sixteenth aspect of the invention, the predefined device operation parameter is a device data transmission rate.

In a seventeenth aspect of the invention, the predefined device operation parameter is a predefined device electrical power consumption limitation or device current limitation.

In a eighteenth aspect of the invention, the device further comprises current sensing circuit means, current supervisor means and electrical power storage means configured to perform a device data transmission speed governing operation.

In an nineteenth aspect of the invention, a USB device is disclosed comprising a solid state disk drive element, a processor element such as an ARM. processor device, a USB interface board comprising a plurality of computer memory elements configured as a plurality of memory banks, a plurality of memory controller elements configured to provide a dedicated memory controller element to each of the plurality of memory banks for the management of data transfer into and out of the respective computer memory elements in the respective memory banks, wherein at least one of the memory controller elements electrically coupled to an anti-tamper module that is in turn electrically coupled to bridge circuit means for the translation of communication protocols between the computer data memory device and an external device.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a block diagram of a preferred embodiment of a computer data memory device of the invention comprising a plurality of dedicated memory controller elements in cooperation with a respective plurality of banks of memory elements.

FIG. 2 depicts an encapsulated substrate of the invention comprising wire bond segments functioning as tamper event sensing structures.

FIGS. 3A and 3B depict the memory controller element and anti-tamper element of the invention in different stacked configurations and electrically coupled by means of a plurality of solder balls.

FIG. 4 depicts a block diagram of a further preferred embodiment of the invention wherein the multiplexing circuitry of the invention comprises a layer element of a stacked module that comprises the anti-tamper module and memory controller layers of the invention.

FIG. 5 depicts a block diagram of yet a further preferred embodiment of the invention wherein the device of the invention is configured so as to negotiate and communicate with a host device to permit the reconfiguration of the USB host port lines to lower power supply impedance.

FIG. 6 depicts a block diagram of a yet further preferred embodiment of the invention wherein the device of the invention comprises a current sensing circuit element and a separately provided electrical power source in the form of a battery, capacitor or other electrical power source to store or supply electrical power for the device for use in leveling power consumption during periods of high or low device data transmission speeds.

FIG. 7 depicts an embodiment of a device of the invention having “safe house” computing capabilities.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

A tamper-resistant, secure portable computer memory device with variable data transmission rate is disclosed.

Turning now to the figures wherein like numerals define like elements among the several views, a first preferred block diagram embodiment of the secure, tamper-resistant computer data memory device 1 is shown.

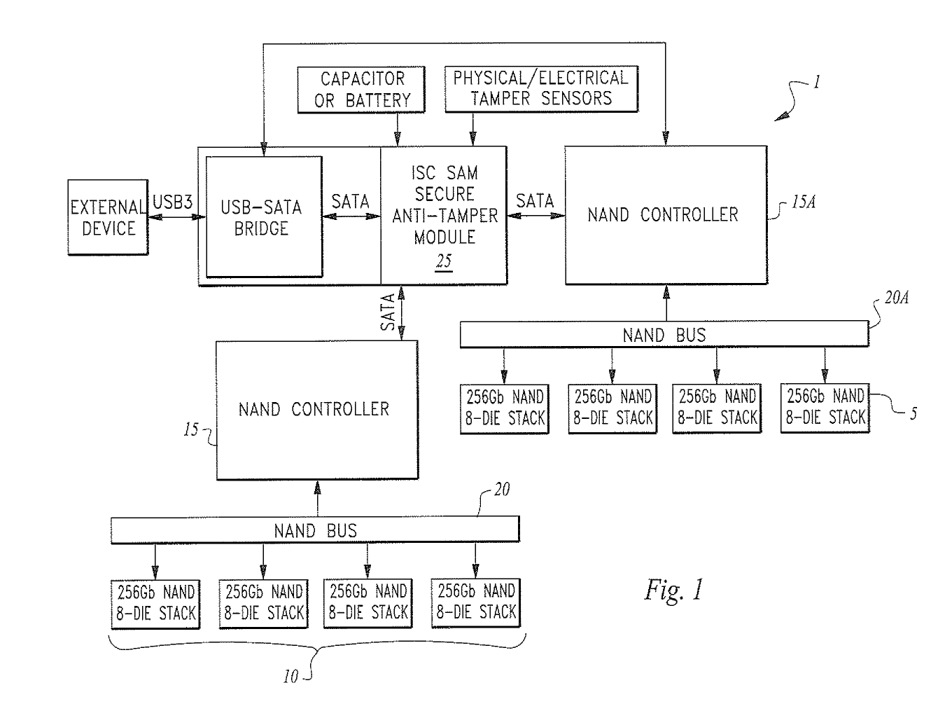

In the preferred embodiment of the invention of FIG. 1, the computer data memory device 1 may comprise one or more computer memory elements 5 which, in the illustrated preferred embodiment comprise a plurality of stacks of layers of electrically coupled and interconnected NAND flash memory semiconductor die.

The invention is not limited to such a memory element configuration and any suitable planar or stacked memory element or set of elements in the form of an IC die, a prepackaged IC chip, a stack of die or stack of prepackaged IC chips may be used in the invention.

The use of electrically-coupled IC memory die stacks has been found to be particularly beneficial for use in the instant invention due to its ability to provide very high memory circuit density per unit volume and the ability of die stacks to operate at very high speeds. These speed and power benefits are primarily the result of greatly reduced electrical lead lengths in the stack(s) of die and the associated reduced parasitic impedance that is achieved as opposed to use of a non-stacked format.

A yet further benefit of the use of a stack of integrated circuit chips is the inherent difficulty an unauthorized user will have in attempting to tamper with, electrically probe or reverse engineer the stack, i.e., the difficulty in identifying the nature, function and I/O locations of the chips in the stack and the difficulty presented in physically reverse engineering or tampering with the device without destroying it such as by grinding, FIB, probing, X-ray, etching or other tampering or reversing engineering methods.

Integrated circuit die stacking was pioneered by ISC8, Inc. (formally known as Irvine Sensors Corporation), assignee of the instant application, as is disclosed for instance in U.S. Pat. No. 5,581,498, “Stack of IC Chips in Liu of Single IC Chip” and other die stacking patents issued and assigned to Irvine Sensors Corp.

Computer memory elements 5 are preferably configured as one or more memory banks 10 of memory elements 5 and are electrically coupled to one or more memory controller elements 15 and 15A by means of a memory bus 20. At least one dedicated memory bank 10 is electrically coupled with and dedicated to anti-tamper module 25 which may comprise secure internal processing means such as a Maxim DS5250 high speed secure microprocessor element, or a MAXQ or DS3640 Maxim device, through memory controller element 15A.

Anti-tamper module 25 may further comprise an embedded or external battery or capacitor element such as an electric double layer capacitor known as a “super capacitor” functioning as a standby power source used to zeroize the contents of the device memory elements or stored encryption keys in the anti-tamper element or other stored contents of device 1 in the event a tamper event is detected to keep volatile memory, RTC circuitry and tamper-detection and zeroization circuitry active and functioning during or after a tamper attempt.

Suitable memory controller element circuitry 15 and 15A is provided such as the Sandforce 1500/2500 line of NAND flash memory controllers which preferably provide a data encryption/decryption function. The Sandforce 1500/2500 line of NAND controllers are well-suited for use in device 1 and may be configured to store data in an AES-256/128 hardware encrypted format to effectively prevent an unauthorized user from extracting data directly from the flash memory elements in the device.

Of particular benefit is the use of a plurality of dedicated memory controller elements 15 and 15A that are in communication with a plurality of associated dedicated memory banks 10. By taking advantage of multiple, memory controller/memory banks and elements, (i.e., 1-n dedicated memory controller-memory bank sets) in the device, operational parallelism and thus, dramatically increased data transfer and encryption/decryption is achieved.

It is expressly noted the configuration of the embodiment illustrated in the figures is not limited to the use of only two dedicated memory controller elements in cooperation with two memory banks and that the device may comprise any predetermined number of separate dedicated memory banks in communication with any number of dedicated memory controller elements. Further, the memory controller elements may be configured to communicate with only the anti-tamper module of the device, only the USB-SATA bridge device or other bridge circuit means or both in any combination desired by the user.

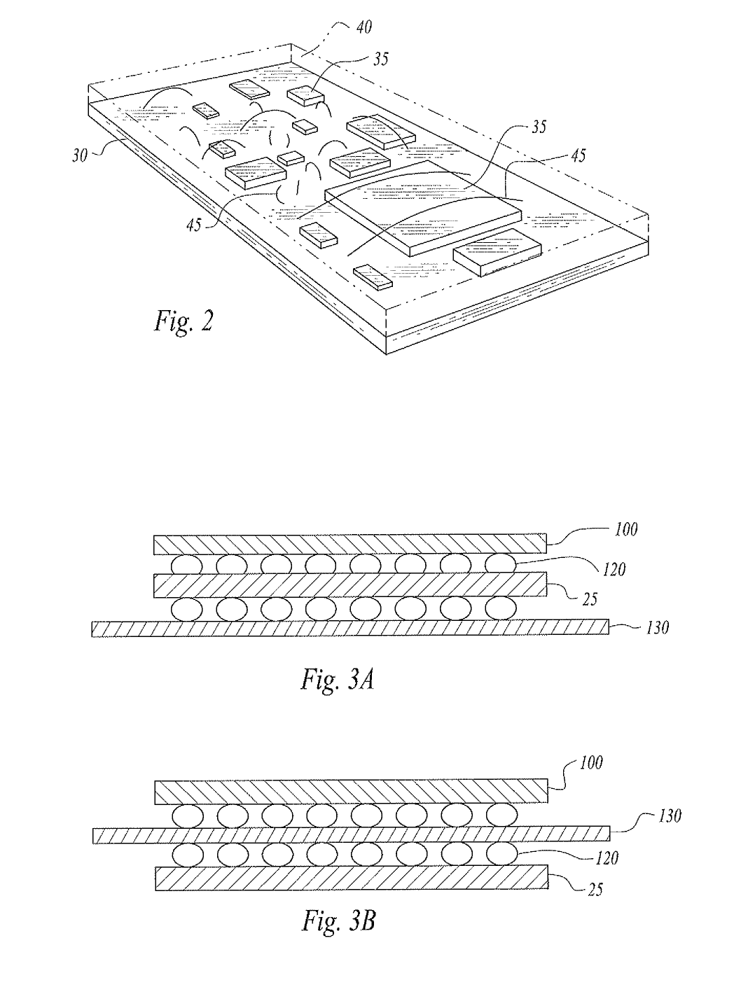

In the anti-tamper computer data memory device 1 embodiment illustrated in FIG. 2, a portion of, or the entirety of selected ones or all of the circuit components 35 comprising the block elements of FIG. 1 may be provided on a substrate 30 that has been “potted” or over-molded with an epoxy or encapsulating material 40 so as to encapsulate the components within the material.

One or more electrically conductive wire segments 45, which may be in the form of wire bond loops or open portions are defined on substrate 30 and are in electrical connection and cooperation with anti-tamper module 25 for providing tamper detection sensing circuitry in device 1.

The wire bond segments 45 are embedded in encapsulating material 45 and may be configured such that when they are electrically broken or connected (i.e., an electrical open or short is detected in the form of a change in continuity in the segment), such as during an attempt to grind into or penetrate encapsulating material 40, an electrical response is provided which in turn triggers a predetermined tamper detection response in the anti-tamper module which may comprise the erasing or “zeroizion” or rewriting of some or all of the contents of the memory elements 5 of the device 1 or of an encryption key or stored information in the anti-tamper module, memory controller or other storage element in the device.

In the embodiment of FIG. 2, a mesh of wire bond segments 45 in the form of loops and open loops is provided at predetermined or random locations or both on substrate 30 of device 1.

The segments 45 may be defined over the upper surface of a component 35 or on the surface of substrate 30 or both and may be electrically connected either individually, as multiple chains, or as a single chain or a combination thereof.

The wire bond segments 45 may be provided as “closed” such that continuity is normal or “open” such that continuity indicates a tamper event or a combination thereof in the event a portion of the encapsulant is ground off in a low level tamper attempt which will expose the open segment ends or break the continuity of a closed segment or both. The wire bond segments 45 in the form of loops or opens or both are electrically coupled with anti-tamper module 25 to sense any breaks/connections of the loops or opens and generate a predetermined tamper response (e.g., erasure of one or more memory contents) such as where an unauthorized user attempts to bypass the open loops by manually electrically shorting them out such as by using a conductive gel/liquid.

Substrate 30 is preferably designed such that all wire bond segments are connected using blind vias (i.e., no exposure to the back side of the device) and the entire module potted in an encapsulating material 40 on one or both sides of board. This embodiment provides additional protection to potted electronics by providing embedded “continuity sensors” that can detect any attempt to expose the internal electronics. Of additional benefit, wire bond segments 45 in the form of closed loops and open loops can be strategically placed over components or sensitive traces to thwart any attempts to bypass wire bonds.

Segments 45 can be made to vary in height, loop length, width, etc. as well as providing conductive wire segments with different heights that are adjacent, as well as using “open” strands of wire bond segments to detect unauthorized attempts at bypassing connections. This makes it difficult to grind down potting material to partially expose bonds and bypass them without generating a tamper response. Wire bonding is easily done with standard technology and is inexpensive.

Means for detecting a tamper event resulting from an attempt to physically breach or probe the memory contents of the device 1 may further comprise the use of nano-trace sensing structures or other tamper-sensing means such are disclosed in U.S. patent application Ser. No. 13/045,880, “Secure Anti-Tamper Integrated Security Device Comprising Nano-Structures”, and Ser. No. 12/806,127, “Tamper-Resistant Electronic Circuit and Module Incorporating Conductive Nano-Structures”, assigned to Irvine Sensors Corp., assignee of the instant application.

The Maxim DS3655 Secure Supervisor from Maxim Integrated Products, Inc. is well-suited for use as an element of anti-tamper module 25 and provides tamper-detection comparator inputs that interface with and provide continuous, low-power monitoring of resistive anti-tamper resistive meshes, external sensors, and digital interlocks. The Maxim DS3655 device provides circuitry that monitors primary power and, in the event of failure, an external or embedded storage capacitor or battery power source is switched in to keep the device and external circuitry active. The DS3655 also monitors battery voltage and initiates a tamper response such as erasure of the contents of the memory elements when the battery voltage becomes abnormal or there is a predetermined temperate limit or rate of change that is exceeded.

Anti-tamper module 25 may be configured to encrypt/decrypt data on its own, using only its internally accessible keys to provide a means for internal, secure computing. This configuration permits authorized users to load and run secure algorithms (algorithms may be loaded into memory elements 25 in real time using standard data encryption techniques, such that anti-tamper module 25 stores the code and externally stored code is fully encrypted). Also, since all encryption keys and encryption key handling is within anti-tamper module 25, these functions are tightly controlled (such as, for example, the ability to store encryption keys in a volatile, non-imprinting, instant-erase memory).

Anti-tamper module 25 is provided with SATA interfaces to permit in-line operation with the USB-SATA bridge and SATA flash controllers.

Encryption/decryption is a primary purpose of anti-tamper module 25, along with implementing the standard anti-tamper sensor elements (e.g., variance in temperature, voltage, anti-tamper mesh monitoring, variance in a predetermined capacitance, inductance or resistance sensed from a conductive structure defined on the surface of or in the device 1 or equivalent tamper-sensing means).

A number of anti-tamper approaches are well-suited for use in the device to provide a generic, anti-tamper, secure module 25. The enhanced circuit elements with anti-tamper functionality in a single stacked package provide a secure building block that can be implement as a subsystem in a variety of different applications and systems requiring secure, tamper-resistant memory. For example, using PET switches in cooperation with anti-tamper module 25 that are embedded into the memory package provides the ability to disable external interfaces and wipe internal encryption keys in a tamper event.

A purpose of the PET switch operation is to provide internal nano-fuses that control PET switches and basically serve to isolate the external interface (e.g., such that during a long zeroization procedure) or to isolate a memory contents after a tamper event so there is no way to access the contents of device or impact its internal performance by attempting to short data lines or hack into the module via an electrical interface. In other words, the internal elements of the anti-tamper module will still operate on power-up to zeroize or perform a tamper event penalty response but external electrical access is eliminated by the blowing of the PET switches.

Stacks comprising integrated circuit memory devices such as DDR memory devices, flash memory devices or SRAM memory devices may be protected in the same manner. Beyond the standard memory interfaces, anti-tamper module 25 requires only a simple interface bus such as I2C or SPI to reload encryption keys and to extract stored tamper information. Secure supervisors such as MAXIM DS3640 can be utilized for encryption key storage and tamper detection.

In one embodiment, an active substrate layer is provided in the anti-tamper module 25. The active substrate may comprise crystal oscillators, filter capacitors, point-of-load (POL) regulators, buffering, and isolation switches for instance. The layer may be directly integrated into the substrate of the stack comprising anti-tamper module 25.

By including POL regulators within the anti-tamper module 25 stack, differential power analysis becomes much more difficult for an unauthorized user since smoothing capacitors before and after regulators mask the output. The POL circuitry further protects against glitch attacks by being able to monitor external and internal voltages which are concerns where the regulation phase delay permits drops in external voltage to be detected prior to an internal drop, thereby providing a window where the internal supervisor can reset the system before seeing any glitch.

Additionally, included oscillators and crystals prevent tampering of core clock functions. By embedding discretes in an active layer in the anti-tamper module 25, the system integration of the anti-tamper module 25 stack is greatly simplified and removes dependence on external systems for security features.

The size, weight, and power or SWaP is also a consideration and the stacked embodiment is beneficial as the physical size and layer thinning reduce weight to a bare minimum with those same stack attributes providing the benefit of reducing power (e.g., reduced capacitive loading). For data storage, a non-volatile static random access memory (NVSRAM) may be integrated into the anti-tamper module 25 stack since it provides a robust storage mechanism without wear issues as may occur in NAND flash cells.

Various secure supervisor circuits and devices exist in the market that can provide hardware accelerated crypto functions; for example, the MAXIM MAXQ series of microcontrollers. Key storage may be provided by specialized, rotating, non-imprinting, battery-backed or storage capacitor-backed SRAM devices such as the DS3640. To provide the processing power for the anti-tamper module 25, an ARM-based processor with anti-tamper features may be incorporated in the device such as the Zatara ZA9L series.

NVSRAM is well-suited for use in the device 1 since it provides fast access (15 ns cycle time), infinite read/write cycles while powered on, over 1,000,000 store cycles, and password protection. NVSRAM functions as normal SRAM while powered on but then automatically stores data when powering off. NVSRAM is capable of storing data on power down using internal SRAM cell capacitance and external capacitors which may be embedded within the anti-tamper module 25 stack.

Note the data storing procedure utilizes SRAM cell capacitance to set the non-volatile state, so is safe even on unintentional shutdowns. The NVSRAM. is also password protected on power-up to enhance security. The protection can be configured to wipe data on incorrect password entry. Data erasure typically requires about <10 ms and cannot. be stopped by removing power (the same quantum technology used to store the SRAM data to non-volatile cells is also used to erase the data).

To improve anti-tamper module support for cryptographic functions, a supervisor chip such as a MAXQ device with hardware accelerated crypto functions (such as AES-256, DES, 3DES, SHA-256, etc.) is provided. This microcontroller is particularly useful for providing supervisory functions in the anti-tamper module 25. A provided storage capacitor or battery-backed RTC consumes less than 1 uA giving the anti-tamper module 25 an almost negligible power footprint in standby modes. The RTC also adds the ability to provide expiration dates and event time-stamping. Internal anti-tamper functions of the MAXQ device such as temperature alarms, mesh monitors, and instant zeroization of keys provide further protection and desirably includes a true random number generator and hard-wired serial number to allow for internal key generation and storage useful in challenge-response algorithms. Auto-key generation is useful for providing additional protection to the NVSRAM in the form of internally generated and held keys that are not known to the outside (such that instant zeroization of internal keys protects data access).

The anti-tamper module 25 may comprise an ARM-based processor, such as the ZAL91 from MAXIM. This is a 200 MHz ARM922T and is capable of running Linux and providing a standard software platform that is easily utilized. The ARM processor interfaces directly to the NVSRAM to provide a secure interface between the external system and internal data. Multiple interfaces, including USB are available at the system level.

The crypto supervisor IC (MAXQ) provides system turn-on functionality, power sequencing, and crypto co-processing. The password protected NVSRAM requires unlocking from the external system via the USB interface to protect internal information. This is coupled with internally generated and held encryption keys used to verify external system rights before powering on. Further cryptographic functions, such as AES-256, may be implemented within blocks of NVSRAM to store sensitive data or algorithms.

Rotating SRAM provides temporary encryption key storage to unlock sensitive algorithms during execution. Furthermore, by physical distribution of key storage into different layers in a multi-layer stack embodiment of anti-tamper module 25, overall tamper protection is improved from physical attacks.

Anti-tamper module 25 circuitry is electrically coupled to a USB-SATA bridge element 50 such as a Symwave SW6318 device via SATA which provides translation of communication protocols between computer data memory device 1 and an external device via a USB connector.

FIG. 3A illustrates an alternative embodiment of computer data memory device 1 comprising a NAND controller 100 in cooperation with anti-tamper module 25 for zeroization of the contents of a memory location in the device such as the AES-key in the NAND controller in the event a tamper event is sensed. NAND controller 100 is electrically coupled to anti-tamper module 25 by means of solder ball connections 120 in a ball grid array format and is bonded to a printed circuit board or substrate 30.

In the alternative embodiment of FIG. 3B, NAND flash controller 100 and anti-tamper module 25 are electrically coupled on opposing surfaces of printed circuit board or substrate 30.

Yet a further embodiment of the anti-tamper module 25 of device 1 may comprise a real-time clock circuit (RTC) allowing for time-based lockdown or operational or functional control of device 1. Exemplar variations within the scope of the invention include, without limitation, configurations whereby the device cannot be read before a predetermined date/time or so that the device will expire and erase itself when powered up after a predetermined time or date has passed or if it is not connected to an approved host device within a predetermined time from the time the cap or cover is removed.

As referenced above, in one embodiment, a USB connector of the device may be provided with a connector cover or cap in acting cooperation with a magnetic, Hall Effect or other switch means in connection with the RTC for generating a predetermined tamper response within the memory contents of the USB memory device 1 when the switch or cap is opened or removed. For instance, device 1 may be provided with an on-board battery or storage capacitor to erase flash memory when the cap is removed even if device 1 not connected to an external power source.

The RTC is preferably used in conjunction with the anti-tamper module or other circuitry to provide an AES key (for example) or other method, and to detect tampering attempts with the circuit. Such configurations may include, by way of example and not by limitation, a configuration where stopping the real time clock or exceeding temperature gradient would generate an anti-tamper event signal to erase a key or the contents of a memory within the device

Device 1 of the invention may be provided with an external anti-tamper resistive mesh structure as is available from W. L. Gore & Associates, Inc. or equivalent structure in the form of one or more electrically conductive traces or patterns defined on the external surface of the device or an element within the device that, when broken or breached, cooperates with anti-tamper module 25 to generate a predetermined tamper response.

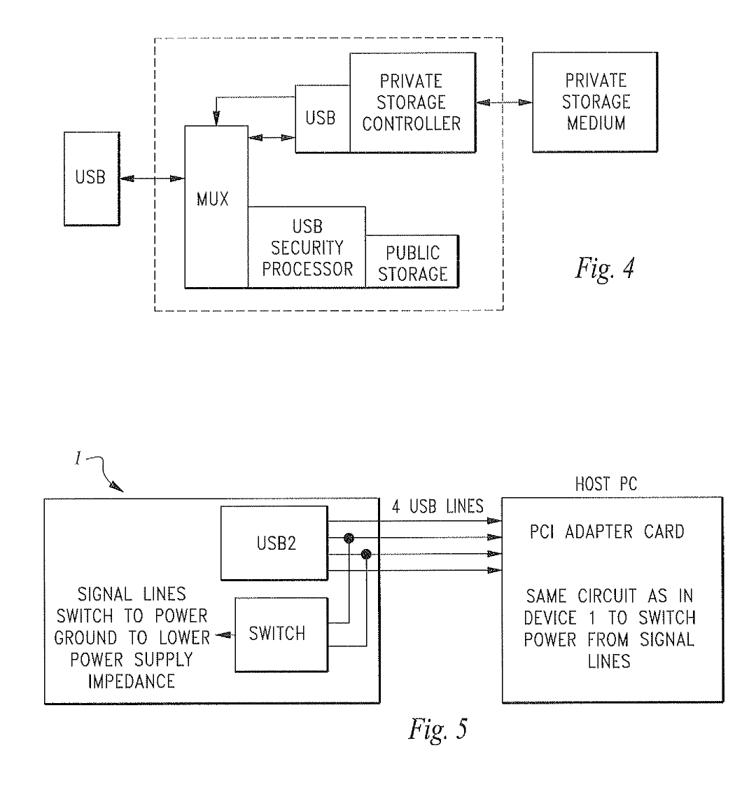

In the preferred embodiment of FIG. 4, USB computer data memory device 1 is used to establish an initial USB connection using a secure processor with internal data storage. In this embodiment, the multiplexing circuitry of the invention comprises a layer element of a stacked module that further comprises the anti-tamper module and memory controllers of the invention.

This configuration permits initial enumeration to a host via a secure processor with public storage and serves to physically isolate the private storage electrical/software interface as well as private storage hardware (which comprises its on security mechanism such as password, AES-256, etc.).

Prior art public/private storage devices are available but undesirably utilize the same physical storage medium and controller, e.g. separate partitions, which potentially “exposes” the private interface.

The public storage of the invention contains necessary interface software to interface to a secure processor. This avoids the necessity of having custom drivers or the need for installing special software in the device.

The public software interfaces to a secure processor and executables which may be run on a PC, making more options available for password generation. For example, the device may be configured to request a password, a network MAC address, hardware serial numbers, hardware components, a key file, public keys from original user, or a time-based key (with comparison from an internal clock to establish an initial security check. If the security check passes, the private storage controller USB enumerates and presents its own security interface (i.e. password for AES-256 as in typical encrypted drive).

The secure processor enumerates using BOT (bulk-only-transfer) and HID (human-interface device) endpoints—these are automatically available on most existing OS, again with no need for custom drivers or pre-installed software.

The disclosed device 1 of FIG. 4 has at least the following benefits over prior art methods and devices. The invention provides additional layers to isolate private hardware from direct probing. When coupled with potting, tamper grids or meshes, protection bonds and the like, it becomes very difficult for an unauthorized user to bypass the multiplexing circuit means (“MUX”) which is embedded in the stacked module that comprises the anti-tamper module 25, the memory controller element 15 and any computer memory element. This greatly increases the difficulty in probing or tampering with the stack in an effort to gain access to the contents of the memory elements that comprise the private storage area of the device.

The invention permits custom security implementations and tighter distribution control not tied to any third party hardware (e.g., it is not dependent on third party drivers/hardware that may have mass distribution, available source code, or sometimes lack information regarding design/code through legitimate channels, etc.).

The invention allows custom executables for security checks that remain consistent with changing hardware. The invention further allows executables to run on a host system to gather information and respond back to the controller which allows more data gathering for key generation. The invention uses “off-grid” hardware to perform key check/storage to reduce code vulnerabilities (non-readable keys). Since code is running on separate hardware from private storage, there are no buffer overflows, out-of-bound, side channels, etc. that can be used to access private controller/data.

Device 1 may be also provided with means for identifying a unique serial number, identifier or label on the device 1 or the contents thereof and may comprise the integration of an LCD or user interface screen into the housing of the invention.

Each device 1 may be preprogrammed with a serial number as a unique identifier that can be stored in a user-defined memory location such as a separately provided EEPROM wherein software on a host PC is used to read the identifier. Optionally, a user can put this information in a separately provided ROM to prevent modification by an unauthorized user. The user interface may be activated with a button or switch or always remain active. Information to be displayed can include, for instance, serial number, movie or music title, capacity used, etc. or similar user information.

Device locking schemes to inhibit or prevent access to the contents of the invention may comprise a secondary USB2 interface that acts as a negotiation between a host PC and device 1 or configured where all data on device 1 is encrypted and where decryption is performed externally such as on a PCIe card having predefined serial number or permission protocols.

Device 1 may be configured so that only an authorized duplication system can unlock or lock the memory contents thereof. The device may be configured to log connections allowing traceability or have contents that can be read out only by an authorized duplication system or to store read/writes, power cycles, active time, etc.

The device may be configured to be locked to a specific host PC PCIe adapter such that it initially acts as a USB 2.0 device and then performs a “negotiation” with the host PC using USB 2.0 physical specifications but using a user-defined proprietary communications protocol such that the device cannot communicate a standard USB 2.0 device so that the device will not open and cannot be read on a normal PC. Upon successful negotiation of a custom PCIe card using a proprietary USB 2.0 protocol with the USB 2.0 port, the drive “opens” a USB 3.0 interface or switches to a standard USB 2.0 device to permit access to the PC.

Additional configuration capabilities may comprise use of RFID tagging capabilities within the device.

FIG. 5 illustrates a preferred block diagram embodiment of a high power, high bandwidth USB interface.

The invention addresses the need for high power USB-attached devices to fully utilize 5 Gbps bandwidth by providing means for current negotiation between the device and the host.

In this embodiment, device 1 is configured to negotiate with a PCIe adapter card and is configured to request or “ask” for more current. Based on the “answer” from the host, device 1. operates at a standard USB 3.0 specification and limits bandwidth to reduce power, or enables full power and maximizes bandwidth in the device. In operation, device 1 is connected to a host PC such as via a PCIe adapter card and “negotiates” using a USB2 protocol with the PC to request more power. If the negotiation results in a grant, the device switches to maximum data transfer speed and reconfigures the device and PCIe to convert the USB signaling lines to an extra power and ground pair to reduce contact resistance.

Slots or apparatus in the housing of device 1 and its USB connector may be provided to allow forced air cooling of device 1 components using an external source such as a forced air source available from the host device.

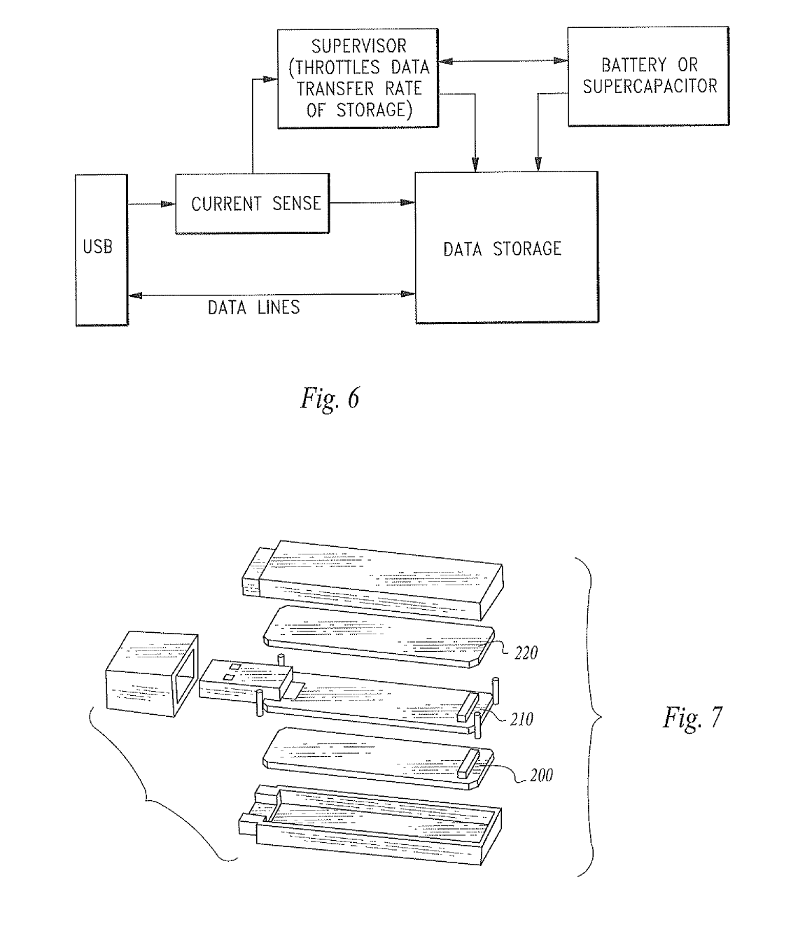

FIG. 6 illustrates a preferred block diagram embodiment of a USB memory device having data transfer rate governing means wherein the device of the invention comprises a current sensing circuit element and a separately provided electrical power source in the form of a battery, capacitor or other power source to store or supply current for the device for use in leveling power consumption during periods of high or low data transmission speeds.

The data transfer rate governing (i.e., ability to regulate) the device data transfer speed in real time is used to control maximum power consumption or, for instance, to stay within the power consumption specifications of a USB 3.0 device. The illustrated embodiment of the device 1 comprises a supervisor chip that monitors maximum power in order to limit or to meet, a predetermined power consumption specification which may comprise, for instance, the Maxim Secure Supervisor chip set cited above, each of which provides current sensing circuitry within the device.

When the drive approaches a predetermined power usage, such as a predetermined maximum power, the data transfer speed is reduced to keep power at or below a predetermined level such as at a USB 3.0 specification.

The data governing mechanism may be used to conserve power consumption in a device. In conjunction with data governing, a super-capacitor or battery or equivalent storage device is used as a power reservoir to allow high power peaks.

The charge and discharge of the battery or capacitor may be monitored and factored by the supervisor circuit in the anti-tamper module 25 to minimize governing and maximize data throughput of the device. This can be used in conjunction with the above “high power” USB device to allow device usage with lower power supplies.

FIG. 7 illustrates a preferred embodiment of a USB “safe house” storage memory device 1. The device of FIG. 7 may comprise a solid state disk drive element, a processor element, an interface board comprising a plurality of computer memory elements configured as a plurality of memory banks, a plurality of memory controller elements configured to provide a dedicated memory controller element to each of the plurality of respective dedicated memory banks for the management of data transfer into and out of the computer memory elements in the bank. In this embodiment, at least one of the memory controller elements is electrically coupled to an anti-tamper module that is electrically coupled to bridge circuit means for the translation of communication protocols between the computer data memory device and an external device.

In a preferred embodiment, device 1 is a USB thumb drive-style device comprising a SSD (solid state drive) 200, a USB interface board 210 for connection to an external PC and computer processing means 220 such as an ARM processor device as is available from ARM Ltd.

The USB device 1 of FIG. 7 may be connected to a host PC and accessed via USB and function similarly to a virtual computer with VPN-like access.

The invention permits a user to take and execute computer programs, etc. with the device of the invention and run those programs on the “safe house” drive that can be mounted either independently or simultaneously as a disc drive by a host operating system.

In this configuration, device 1 functions as a safe house computing environment that can also be mounted independently or simultaneously as a disk drive by host operating system (can use public regions, etc.) and can provide “firewalls” in safe house to run those programs securely.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims arc thus to be understood to include what is specifically illustrated and described above, what is conceptually equivalent, what can be obviously substituted and also what essentially incorporates the essential idea of the invention.

We claim:

1. A computer data memory device comprising:
a plurality of computer memory elements configured as a plurality of memory banks,
a plurality of memory controller elements configured to provide a dedicated memory controller element to each of the plurality of memory banks for the independent management of data transfer into and out of the respective computer memory elements in the respective memory banks, and,
at least one of the memory controller elements electrically coupled to bridge circuit means for the translation of communication protocols between the computer data memory device and an external device.

2. A computer data memory device comprising:
a plurality of computer memory elements configured as a plurality of memory banks,
a plurality of memory controller elements configured to provide a dedicated memory controller element to each of the plurality of memory banks for the independent management of data transfer into and out of the respective computer memory elements in the respective memory banks, and,
at least one of the memory controller elements electrically coupled to an anti-tamper module that is electrically coupled to bridge circuit means for the translation of communication protocols between the computer data memory device and an external device.

3. The device of claim 2 wherein the anti-tamper module performs a data encryption or decryption operation.

4. The device of claim 2 comprising a stack of electrically coupled integrated circuit layers wherein at least one of the layers comprises at least one of the computer memory elements.

5. The device of claim 2 wherein the anti-tamper module is configured to sense a variance in a predetermined electrical characteristic whereby a predetermined variance in the predetermined electrical characteristic initiates a predetermined tamper response from the anti-tamper module.

6. The device of claim 5 wherein the predetermined electrical characteristic comprises a predetermined electrical resistance.

7. The device of claim 5 wherein the predetermined electrical characteristic comprises a predetermined electrical capacitance.

8. The device of claim 5 wherein the predetermined electrical characteristic comprises a predetermined electrical inductance.

9. The device of claim 5 wherein the predetermined tamper response comprises erasing a memory contents or encryption key in the device.

10. The device of claim 5 wherein the predetermined variance is sensed as a result of an open connection in a wire bond segment embedded in an encapsulating material.

11. The device of claim 5 wherein the predetermined variance is sensed as a result of a change in an electrical continuity through a wire bond segment embedded in an encapsulating material.

12. The device of claim 5 wherein the anti-tamper module further comprises a real time clock circuit configured to permit time-based access to the contents of at least one of the computer memory element based on a predetermined tamper event.

13. The device of claim 5 comprising a stack of electrically coupled integrated circuit layers wherein at least one of the layers comprises a memory controller element and at least one of the layers comprises an anti-tamper module.

14. The device of claim 13 wherein the stack of layers further comprises a layer comprising multiplexing circuit means.

15. The device of claim 2 configured to communicate with a host whereby the device operates at a predefined device operation parameter based on a predefined host communication response.

16. The device of claim 15 wherein the predefined device operation parameter is a device data transmission rate.

17. The device of claim 15 where the predefined device operation parameter is a predefined device electrical power consumption limitation.

18. The device of claim 2 further comprising current sensing circuit means, current supervisor means configured to perform a device data transmission speed governing operation and electrical power storage means.

19. A portable safe house computing device comprising:
a solid state disk drive element,
a processor element,
an interface board comprising a plurality of computer memory elements configured as a plurality of memory banks,
a plurality of memory controller elements configured to provide a dedicated memory controller element to each of the plurality of memory banks for the management of data transfer into and out of the computer memory elements in the memory bank, and,
at least one of the memory controller elements electrically coupled to an anti-tamper module that is electrically coupled to bridge circuit means for the translation of communication protocols between the computer data memory device and an external device.
